(19) United States
(12) Patent Application Publication
(10) Pub. No.: US 2013/0147762 A1
(43) Pub. Date: Jun. 13, 2013

(54) OPTICAL NAVIGATION MODULE AND LENS FOR OPTICAL NAVIGATION MODULE

(71) Applicants: Jin Mun Ryu, Gyunggi-do (KR); Ho Sik You, Gyunggi-do (KR)

(72) Inventors: Jin Mun Ryu, Gyunggi-do (KR); Ho Sik You, Gyunggi-do (KR)

(73) Assignee: SAMSUNG ELECTRO-MECHANICS CO., LTD., Gyunggi-do (KR)

(21) Appl. No.: 13/409,819

(22) Filed: Mar. 1, 2012

(30) Foreign Application Priority Data
Dec. 13, 2011 (KR) 1020110133776

(51) Int. Cl. G06F 3/042; G02B 5/02

(52) U.S. Cl. 345/175; 359/707

(57) ABSTRACT

Disclosed herein is an optical navigation module, including: an LED that is a light source diffusing light; a lens having a light transmitting part and a light receiving part integrally formed and refracting and collecting light diffused from the light source; a window transmitting light diffused from the LED and light reflected by a subject; and a sensor receiving light reflected from the window, detecting the received light, and outputting the detected light as a signal.

### CROSS REFERENCE TO RELATED APPLICATION

This application claims the benefit of Korean Patent Application No. 10-2011-0133776, filed on Dec. 13, 2011, entitled “Lens and Optical Navigation Module having the same”, which is hereby incorporated by reference in its entirety into this application.

### BACKGROUND OF THE INVENTION

1. Technical Field

The present invention relates to an optical navigation and a lens for an optical navigation module.

2. Description of the Related Art

Generally, personal mobile communication terminals, such as a cellular phone, a smart phone, or the like, includes a user interface using a keypad that includes input buttons for a number, a character, and a direction.

Recently, as wireless internet services such as wibroless broadband (WIBRO) services are commercialized, the personal mobile communication terminal adopts a windows operating system supporting a graphical user interface (GUI).

A development of input devices suitable for a mobile communication terminal and conveniently used by users while adopting the operating system of the GUI as the user interface of the personal mobile communication terminal described above has been urgently required. As a result, a touch key, a joystick, an optical pointing device, or the like, that sequentially perform an input operation using a keypad displayed on a display screen of the mobile communication terminal have been developed. One of them is an optical navigation module.

Further, the optical navigation module (referred to as an optical joystick module) according to the prior art that is used for the mobile communication terminals selects desired icons and menus by controlling a cursor generated on the display.

The optical navigation module is implemented to manipulate a portable terminal by changing an optical signal input to a sensor according to a movement of a finger when a subject, that is, a finger moves while touching a contacting surface.

Meanwhile, various kinds of optical navigation modules have been developed according to a trend of recently released mobile communication terminals. However, a demand for a slimmer optical navigation module has been increased.

### SUMMARY OF THE INVENTION

The present invention has been made in effort to provide an optical navigation module capable of being easily assembled and increasing a degree of freedom in a design by including a lens in which a light transmitting part and a light receiving part are integrally formed, more efficiently tilting light by adopting the light transmitting part as a Fresnel lens, and compactly implementing a height of a module by implementing the light receiving part as a tilted lens and a lens for an optical navigation module.

According to a preferred embodiment of the present invention, there is provided an optical navigation module, including: an LED that is a light source diffusing light; a lens having a light transmitting part and a light receiving part integrally formed and refracting and collecting light diffused from the light source; a window transmitting light diffused from the LED and light reflected by a subject; and a sensor receiving light reflected from the window, detecting the received light, and outputting the detected light as a signal.

The light transmitting part may be configured of a Fresnel lens so as to refract light diffused to the LED and transmit the refracted light to the window.

The light receiving part may be formed to be tilted to a lens mounting surface so as to collect light reflected from the window and transmit the collected light to the sensor.

The optical navigation module may further include a lead that is a shielding part partially covering the LED and the sensor and shielding an introduction of spill light.

The lead may be provided with a rectangular penetrating part that is an open part so as to diffuse light from the LED toward the window and a circular hole that is an open part so as to input light reflected and refracted from the window to the sensor.

The lead may be further provided with a barrier rib that partitions the LED and the sensor.

The optical navigation module may further include a lighting device diffusing light to an outside of a housing.

A top of the housing may be made of transparent or translucent materials and light from the lighting device may be diffused to the outside of the housing through the top thereof.

The optical navigation module may further include a printed circuit board mounted with the LED and the sensor.

According to another preferred embodiment of the present invention, there is provided a lens for an optical navigation module, wherein a light transmitting part and a light receiving part refracting and collecting light diffused from a light source are integrally formed, the light transmitting part is configured of a Fresnel lens for refracting the light diffused from the light source, and the light receiving part is formed to have a tilted angle for collecting light incident thereon.

### BRIEF DESCRIPTION OF THE DRAWINGS

FIG. 1 is a schematic cross-sectional view of an optical navigation module according to a preferred embodiment of the present invention.

FIG. 2 is a front view schematically showing a configuration of a portion of the optical navigation module shown in FIG. 1.

FIG. 3 is a perspective view schematically showing a lens of the optical navigation module shown in FIG. 1.

FIG. 4 is a schematic using state diagram of an optical navigation module according to a preferred embodiment of the present invention.

### DESCRIPTION OF THE PREFERRED EMBODIMENTS

Various objects, advantages and features of the invention will become apparent from the following description of embodiments with reference to the accompanying drawings.

The teams and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. In addition, the terms “first”, “second”, “one surface”, “the other surface” and so on are used to distinguish one element from another element, and the elements are not defined by the above terms. Further, when it is determined that the detailed description of the known art related to the present invention may obscure the gist of the present invention, the detailed description thereof will be omitted.

Hereinafter, an optical navigation module and a lens for an optical navigation module according to preferred embodiments of the present invention will be described in detail below with reference to the accompanying drawings.

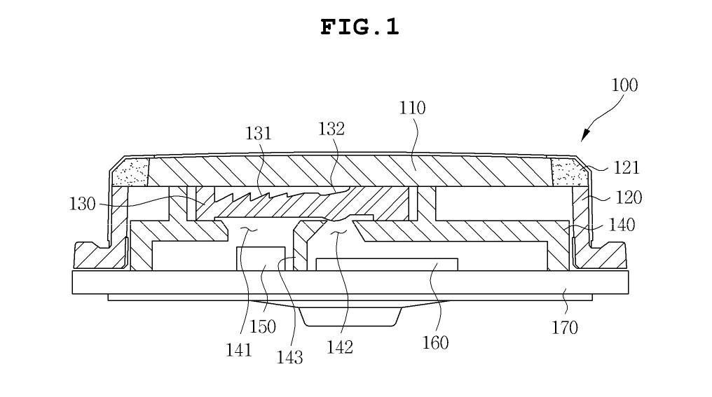

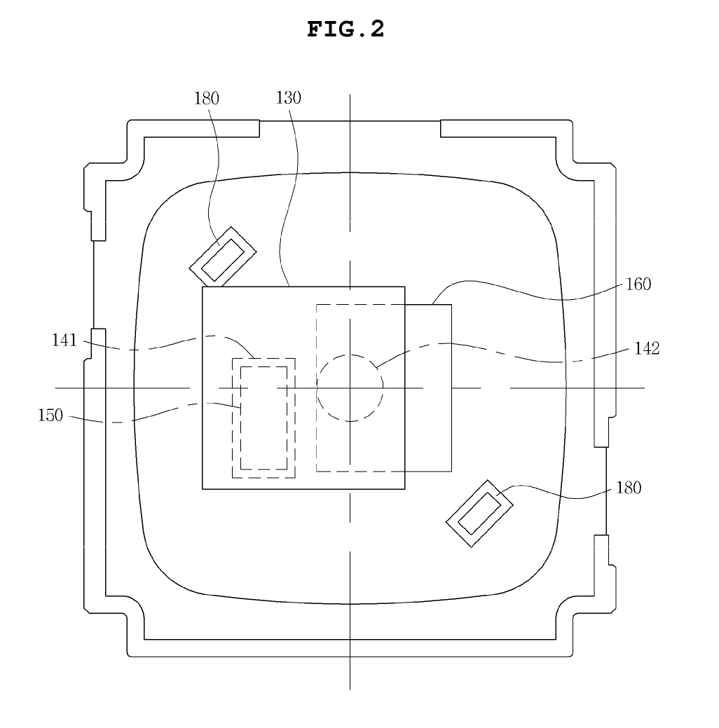

FIG. 1 is a schematic cross-sectional view of an optical navigation module according to a preferred embodiment of the present invention and FIG. 2 is a front view schematically showing a configuration of a portion of the optical navigation module shown in FIG. 1.

As shown, the optical navigation module includes a window 110, a housing 120, a lens 130, a lead 140, an LED 150, a sensor 160, a printed circuit board 170, and a lighting device 180.

Further, in the optical navigation module according to the preferred embodiment of the present invention, a top of the printed circuit board 170 is mounted with the LED 150 and the sensor 160 and is mounted with the lead 140 so as to partially cover the LED 150 and the sensor 160 according to the stacked sequence.

Further, a top of the lead 140 is mounted with the lens 130 so as to face the LED 150 and the window 110 is mounted in a housing 120 so as to be disposed on a top of the lens, wherein the housing 120 is coupled with the printed circuit board 170 so as to cover the lens 130, the lead 140, the LED 150, the sensor 160, and the lighting device 180.

In addition, the lighting device 180 is mounted on the printed circuit board 170.

In more detail, the LED 150 may be implemented as an IR LED 150 that diffuses infrared rays as a light source.

Further, a photodiode of the sensor 160 detects light that is received by reflecting and refracting light diffused from the LED 150 through the window and a control part outputs and processes the detected light as a signal to move a cursor in a direction in which a subject moves.

To this end, the sensor integrally or separately includes the control part.

Further, the lighting device 180 is to diffuse light to the outside of the housing. To this end, the optical navigation module 100 according to the preferred embodiment of the present invention may be configured to further include a light diffusing member (not shown) for uniformly diffusing the light diffused from the light device to the outside of the housing.

Further, the light diffusing member is provided between the lighting device 180 and the housing. In addition, the lighting device 180 may be configured of an LED.

Further, the light diffusing member (not shown), which is to uniformly diffuse the light diffused from the lighting device 180 to the outside through a circumference of the housing, is provided between the housing and the lighting device.

In addition, the light diffusing member may be provided with a protruding portion for switching and diffusing a progress direction of light.

Further, the lead 140 is implemented as a shielding part for shielding an introduction of spill light and is provided with a rectangular penetrating part 141 and a circular hole 142 that are an open part.

In more detail, the light from the LED 150 is diffused toward the window 110 through the rectangular penetrating part 141 and the light reflected and refracted from the window is incident on the sensor 160 through the circular hole 142.

In addition, the lead 140 is provided with a barrier rib 143 that partitions the LED 150 and the sensor 160.

In addition, the lead 140 of the optical navigation module 100 according to the preferred embodiment of the present invention may be further provided with a lighting penetrating part (not shown) for diffusing light from the lighting device 180 to the outside.

Further, the lens 130 refracts the light diffused from the LED 150 and collects light reflected from the window.

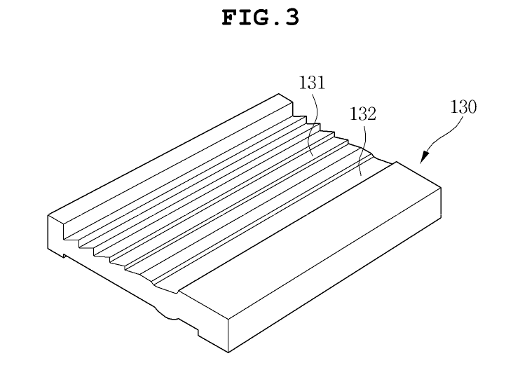

In more detail, FIG. 3 is a perspective view schematically showing a lens of the optical navigation module shown in FIG. 1. As shown in FIG. 3, the lens 130 is configured to include a light transmitting part 131 and a light receiving part 132.

In addition, the light transmitting part 131 refracts the light diffused from the LED 150 and transmits the refracted light to the window 110 and is configured of a Fresnel lens as shown in FIG. 3. In addition, unlike FIG. 3, the light transmitting part 131 may also be implemented by a Fresnel lens that is configured of being divided into several concentric rings.

In addition, the light receiving part 132 is formed to be tilted to a mounting surface of the lens so as to collect the light reflected from the window 110 and transmit the collected light to the sensor 160.

As described above, the lens 130 according to the preferred embodiment of the present invention can be easily assembled and have the increased degree of freedom in a design by integrally forming the light transmitting part 131 and the light receiving part 132 and more efficiently implement a tilt of light by adopting the light transmitting part 131 as the Fresnel lens, and the height of the module according to the preferred embodiment of the present invention can be compactly implemented by implementing the light receiving part 132 as the tilted lens.

Further, the window 110 transmits and reflects the light diffused from the LED 150 and blocks the introduction of visible rays.

Further, as described above, the housing 120 is coupled with the printed circuit board 170 so as to cover the lens 130, the lead 140, the LED 150, the sensor 160, and the lighting device 180 and diffuses the light diffused from the lighting device 180 to the outside of the optical navigation module.

To this end, the housing 120 may be partially made of transparent or translucent materials. To this end, as shown in FIG. 1, only an edge 121 of the top coupled with the window may be made of transparent translucent materials.

In addition, as another preferred embodiment of the present invention, the whole housing according to the preferred embodiment of the present invention may be made of the transparent or translucent materials and may be partially formed with a shielding part.

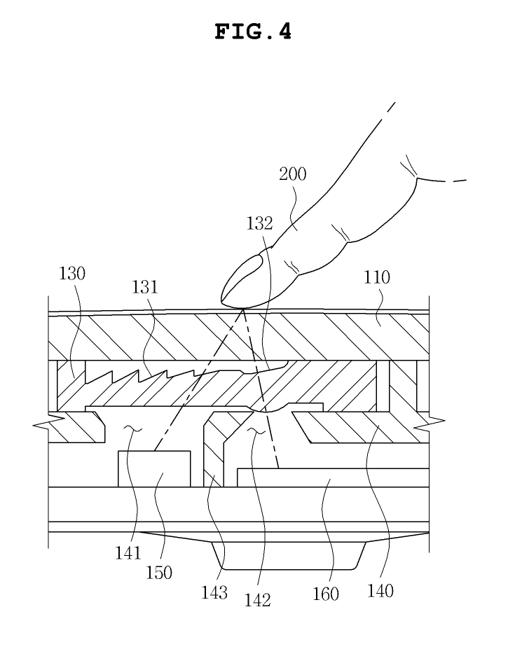

FIG. 4 is a schematic using state diagram of an optical navigation module according to a preferred embodiment of the present invention. As shown in FIG. 4, in the optical navigation module 100, the light diffused from the LED 150 is incident on the light transmitting part 131 of the lens 130 through the rectangular penetrating part 141 of the lead 140 and the light refracted through the light transmitting part 131 that is the Fresnel lens is incident on the window 110.

Further, in the window 110, the light is reflected by a subject 200 that is a portion of a user body, or the like, and is collected through the light receiving part 132 of the lens 130 and the collected light is incident on the sensor 160 through the circular hole 142 of the lead 140.

The optical navigation module according to the preferred embodiments of the present invention can be easily assembled and have the increased degree of freedom in a design by including the lens in which the light transmitting part and the light receiving part are integrally formed and more efficiently implement the tilt of light by adopting the light transmitting part as the Fresnel lens, and compactly implement the height of the module by implementing the light receiving part as the tilted lens.

Although the preferred embodiments of the present invention have been disclosed for illustrative purposes, they are for specifically explaining the present invention and thus a semiconductor package module according to the present invention is not limited thereto, but those skilled in the art will appreciate that various modifications, additions and substitutions are possible, without departing from the scope and spirit of the invention as disclosed in the accompanying claims.

What is claimed is:

1. An optical navigation module, comprising:
an LED that is a light source diffusing light;
a lens having a light transmitting part and a light receiving part integrally formed and refracting and collecting light diffused from the light source;
a window transmitting light diffused from the LED and light reflected by a subject; and
a sensor receiving light reflected from the window, detecting the received light, and outputting the detected light as a signal.

2. The optical navigation module as set forth in claim 1, wherein the light transmitting part is configured of a Fresnel lens so as to refract light diffused to the LED and transmit the refracted light to the window.

3. The optical navigation module as set forth in claim 1, wherein the light receiving part is formed to be tilted to a lens mounting surface so as to collect light reflected from the window and transmit the collected light to the sensor.

4. The optical navigation module as set forth in claim 1, further comprising a lead that is a shielding part partially covering the LED and the sensor and shielding an introduction of spill light.

5. The optical navigation module as set forth in claim 4, wherein the lead is provided with a rectangular penetrating part that is an open part so as to diffuse light from the LED toward the window and a circular hole that is an open part so as to input light reflected and refracted from the window to the sensor.

6. The optical navigation module as set forth in claim 4, wherein the lead is further provided with a barrier rib that partitions the LED and the sensor.

7. The optical navigation module as set forth in claim 1, further comprising a lighting device diffusing light to an outside of a housing.

8. The optical navigation module as set forth in claim 7, wherein a top of the housing is made of transparent or translucent materials and light from the lighting device is diffused to the outside of the housing through the top thereof.

9. The optical navigation module as set forth in claim 1, further comprising a printed circuit board mounted with the LED and the sensor.

10. A lens for an optical navigation module, wherein a light transmitting part and a light receiving part refracting and collecting light diffused from a light source are integrally formed, the light transmitting part is configured of a Fresnel lens for refracting the light diffused from the light source, and the light receiving part is formed to have a tilted angle for collecting light incident thereon.
